(19) United States
(12) Patent Application Publication
(10) Pub. No.: US 2016/0116377 A1
(43) Pub. Date: Apr. 28, 2016

(54) FAILURE PREDICTION APPARATUS AND FAILURE PREDICTION SYSTEM

(71) Applicant: FUJI XEROX CO., LTD., Tokyo (JP)

(72) Inventor: Koki UWATOKO, Kanagawa (JP)

(73) Assignee: FUJI XEROX CO., LTD., Tokyo (JP)

(21) Appl. No.: 14/707,412

(22) Filed: May 8, 2015

(30) Foreign Application Priority Data
Oct. 23, 2014 (JP) 2014-216608

(51) Int. Cl. G01M 99/00; G06F 17/18

(52) U.S. Cl. CPC G01M 99/008; G06F 17/18

(57) ABSTRACT

A failure prediction apparatus includes an acquisition unit that acquires, from plural apparatuses to be monitored, state feature amount groups, a classification unit that classifies the plural apparatuses to be monitored for each degree of separation between a reference space which is defined by the plural state feature amount groups acquired by the acquisition unit and the state feature amount group of each of the plural apparatuses to be monitored, and a calculation unit that specifies a class which is classified by the classification unit and corresponds to the degree of separation between the reference space and the state feature amount group of an apparatus to be monitored and subjected to a failure prediction process among the plural apparatuses to be monitored, and calculates a probability of a failure occurring in the apparatus to be monitored and subjected to the failure prediction process.

### CROSS-REFERENCE TO RELATED APPLICATIONS

This application is based on and claims priority under 35 USC 119 from Japanese Patent Application No. 2014-216608 filed Oct. 23, 2014.

### BACKGROUND

### Technical Field

The present invention relates to a failure prediction apparatus and a failure prediction system.

### SUMMARY

According to an aspect of the invention, there is provided a failure prediction apparatus including:

an acquisition unit that acquires, from plural apparatuses to be monitored, state feature amount groups which are plural state feature amounts indicating features of an operating state of the apparatuses to be monitored;

a classification unit that classifies the plural apparatuses to be monitored for each degree of separation between a reference space which is defined by the plural state feature amount groups acquired by the acquisition unit and the state feature amount group of each of the plural apparatuses to be monitored; and

a calculation unit that specifies a class which is classified by the classification unit and corresponds to the degree of separation between the reference space and the state feature amount group of an apparatus to be monitored and subjected to a failure prediction process acquired by the acquisition unit for a predetermined period among the plural apparatuses to be monitored, and calculates a probability of a failure occurring in the apparatus to be monitored and subjected to the failure prediction process, using the state feature amount group related to the apparatus to be monitor included in the class.

### BRIEF DESCRIPTION OF THE DRAWINGS

Exemplary embodiments of the present invention will be described in detail based on the following figures, wherein:

FIG. 1 is a schematic diagram illustrating an example of the structure of a main portion of a failure prediction system according to first to fourth exemplary embodiments;

FIG. 2 is a schematic distribution diagram illustrating an example of a reference space and a state feature amount group of a machine A having a large degree of variation in the state feature amount group;

FIG. 3 is a schematic distribution diagram illustrating an example of the reference space and a state feature amount group of the machine A having a small degree of variation in the state feature amount group;

FIG. 4 is a graph illustrating an example of a unit Mahalanobis distance related to a state feature amount which is acquired for each job in the range of a period ΔT₁;

FIG. 5 is a block diagram illustrating an example of the hardware configuration of an electrical system of a management apparatus included in the failure prediction system according to the first to fourth exemplary embodiments;

FIG. 6 is a conceptual diagram illustrating an example of content stored in a secondary storage unit of the management apparatus illustrated in FIG. 5;

FIG. 7 is a flowchart illustrating an example of the flow of a failure prediction preparation process according to the first exemplary embodiment;

FIG. 8 is a conceptual diagram illustrating an example of the relationship between the average Mahalanobis distance of the machine A, the average Mahalanobis distance of a machine B, and a classification condition;

FIGS. 9A and 9B are distribution diagrams illustrating an example of the distributions of the state feature amount for a normal period and an abnormal period;

FIG. 10 is a flowchart illustrating an example of the flow of a failure prediction process according to the first exemplary embodiment;

FIG. 11 is a flowchart illustrating an example of the flow of a failure prediction preparation process according to the second exemplary embodiment;

FIG. 12 is a flowchart illustrating an example of the flow of a failure prediction process according to the second exemplary embodiment;

FIG. 13 is a flowchart illustrating an example of the flow of a failure prediction preparation process according to the third exemplary embodiment;

FIG. 14 is a flowchart illustrating an example of the flow of a failure prediction process according to the third exemplary embodiment;

FIG. 15 is a flowchart illustrating an example of the flow of a failure prediction process according to the fourth exemplary embodiment; and

FIG. 16 is a conceptual diagram illustrating an example of notification forms according to the first to fourth exemplary embodiments.

### DETAILED DESCRIPTION

Hereinafter, exemplary embodiments of the invention will be described in detail with reference to the drawings. Hereinafter, for convenience of explanation, the type of failure is referred to as a “failure type”. In addition, hereinafter, for convenience of explanation, a position where a failure occurs is referred to as a “failure occurrence position”.

### First Exemplary Embodiment

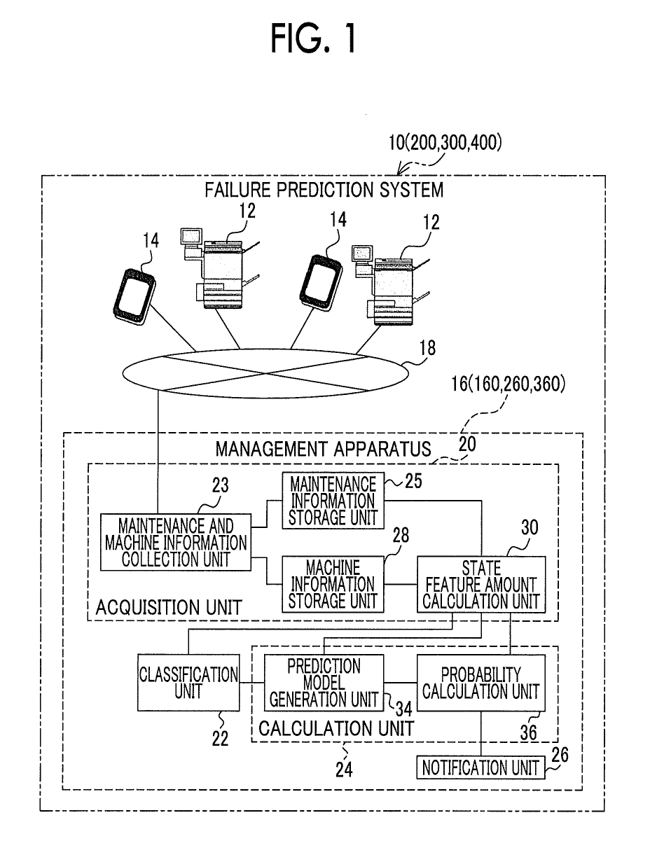

For example, as illustrated in FIG. 1, a failure prediction system 10 includes plural image forming apparatuses 12, plural terminal apparatuses 14, and a management apparatus 16 which is an example of a failure prediction apparatus according to an exemplary embodiment of the invention, which are connected to each other through a communication network 18. An example of the communication network 18 is a dedicated line or an Internet network.

The image forming apparatus 12, which is an example of an apparatus to be monitored according to an exemplary embodiment of the invention, forms an image on a recording material, such as paper or an OHP sheet, and outputs the recording material. An example of the image forming apparatus is a printer, a copier, a facsimile apparatus, or a multi-function machine having the functions of these apparatuses. In the first exemplary embodiment, for convenience of explanation, it is premised that the image forming apparatus 12 is a xerographic type.

The image forming apparatus 12 has a function of detecting plural monitoring parameters related to an image forming process at any time while an image is being formed. The monitoring parameters are predetermined as parameters which contribute to predicting the occurrence of a failure in the image forming apparatus 12. Examples of the monitoring parameters include the potential of a photoconductor, the electrification current of the photoconductor, the amount of semiconductor laser light, the concentration of toner in a developing device, the transfer current of a primary transfer unit, the transfer current of a secondary transfer unit, the temperature of a roller included in a fixing device, and the density of a patch.

When receiving a command to perform a series of processes (job) for forming images related to one page or plural pages on the recording material, the image forming apparatus 12 detects the monitoring parameters whenever forming the images on the recording material and outputting the recording material in response to the job execution command (for example, for each page). Then, after all of the image forming processes corresponding to the job execution command are completed, the image forming apparatus 12 transmits machine information including the monitoring parameters to the management apparatus 16 through the communication network 18.

The machine information is data including, for example, an apparatus ID for identifying a host apparatus, a job ID for identifying a job execution command, the monitoring parameters for each image forming process based on the job execution command, and detection date and time information indicating a detection date and time.

In the first exemplary embodiment, for convenience of explanation, the example in which the machine information is transmitted to the management apparatus 16 whenever the image forming process based on the job execution command is completed has been described. However, the invention is not limited thereto. For example, the machine information may be temporarily stored in a memory of the image forming apparatus 12 and the machine information which is stored in the memory and has not been transmitted may be transmitted to the management apparatus 16 when a predetermined transmission condition is satisfied. For example, when a predetermined period of time (for example, 1 hour) has elapsed, the machine information may be transmitted to the management apparatus 16. Alternatively, the machine information may be transmitted to the management apparatus 16 in response to a request from the management apparatus 16.

The terminal apparatus 14 is used by, for example, the administrator or maintenance worker of the image forming apparatus 12. An example of the terminal apparatus 14 is a personal computer, a smart device, or a wearable terminal apparatus.

The terminal apparatus 14 includes a communication interface, a receiving device, and a display device. The communication interface includes a wireless communication processor and an antenna and performs communication between the terminal apparatus 14 and an external apparatus connected to the communication network 18. In addition, the terminal apparatus 14 receives maintenance information related to maintenance work from, for example, a maintenance worker who visits the installation place of the image forming apparatus 12 and actually performs maintenance work or a person who receives a maintenance report, using the receiving device, and transmits the received maintenance information to the management apparatus 16. When the prediction result of the occurrence of a failure in the image forming apparatus 12 is transmitted from the management apparatus 16, the terminal apparatus 14 receives the prediction result and displays the received prediction result on the display device.

The maintenance information is data including, for example, an apparatus ID for identifying the image forming apparatus 12 to be subjected to maintenance, maintenance date and time information indicating the date and time when maintenance work has been performed, failure type information indicating the type of failure removed by the maintenance work, failure date and time information indicating the date and time when a failure has occurred, and failure occurrence position information indicating the position where a failure has occurred. That is, the maintenance information is also referred to as information indicating a trouble occurrence case.

The management apparatus 16 predicts the occurrence of a failure in the image forming apparatus 12 and includes an acquisition unit 20, a classification unit 22, a calculation unit 24, and a notification unit 26. All of the plural image forming apparatuses 12 connected to the communication network 18 may be subjected to a failure prediction process. The user inputs an instruction to the management apparatus 16 to determine the image forming apparatus 12 to be subjected to the failure prediction process among the plural image forming apparatuses 12.

The acquisition unit 20 acquires, from the plural image forming apparatuses 12, state feature amount groups which are plural state feature amounts indicating the features of the operating state of the image forming apparatuses 12. Examples of the state feature amount which is a component of the state feature amount group include a functional physical amount which is unique to the functions of the image forming apparatus 12 and various statistics for characterizing the behavior of the functional physical amount, such as statistics indicating the degree of variation in the functional physical amount and the amount of change in the functional physical amount. Hereinafter, the state feature amount group is referred to as a “state feature amount group A”. In the first exemplary embodiment, a monitoring parameter is used as an example of the functional physical amount.

The classification unit 22 classifies the plural image forming apparatuses 12 for each degree of separation between a reference space which is defined by a state feature group (hereinafter, referred to as a “state feature amount group B”) indicating the degree of variation in the functional physical amount among the state feature amount groups A acquired by the acquisition unit 20 and the state feature amount group B of each of the plural image forming apparatuses 12. In this exemplary embodiment, the degree of separation indicates how far some objects (for example, the state feature amount group A and the state feature amount group B) are separated from each other. Specifically, the degree of separation may be represented by a Mahalanobis distance which will be described below. Any other method, such as a Euclidean distance, may be used to represent the degree of separation as long as they may indicate how far the state feature amount group A and the state feature amount group B are separated from each other. However, it is preferable to use the Mahalanobis distance rather than the Euclidean distance, in order to accurately calculate the probability of a failure occurring.

The calculation unit 24 calculates the probability of a failure occurring in the image forming apparatus to be subjected to the failure prediction process among the plural image forming apparatuses 12, using the state feature amount group A related to the image forming apparatus 12 which is included in a specific class among the classes classified by the classification unit 22. Here, the specific class indicates a class corresponding to the degree of separation between the reference space and the state feature amount group B, which is acquired from the image forming apparatus to be subjected to the failure prediction process for a period ΔT₁ by the acquisition unit 20, among the classes classified by the classification unit 22.

In the first exemplary embodiment, an example of the period ΔT₁ is six months. However, the invention is not limited thereto. For example, the period ΔT₁ may be a period of several months or a period of several years. In addition, in the first exemplary embodiment, an example of the reference space is a space in which the state feature amounts are most densely concentrated among all of the state feature amount groups B which are acquired from the plural image forming apparatuses 12 by the acquisition unit 20.

The notification unit 26 notifies the probability calculated by the calculation unit 24. For example, probability information indicating the probability calculated by the calculation unit 24 is transmitted to the terminal apparatus 14 and the probability indicated by the probability information is displayed on the display device of the terminal apparatus 14.

The acquisition unit 20 includes a maintenance and machine information collection unit 23, a maintenance information storage unit 25, a machine information storage unit 28, and a state feature amount calculation unit 30.

The maintenance and machine information collection unit 23 receives the machine information transmitted from the image forming apparatus 12, collects the machine information, and stores the collected machine information in the machine information storage unit 28 in time series. In this way, the maintenance and machine information collection unit 23 stores the machine information in the machine information storage unit 28. In addition, the maintenance and machine information collection unit 23 receives the maintenance information transmitted from the terminal apparatus 14, collects the maintenance information, and stores the collected maintenance information in the maintenance information storage unit 25 in time series. In this way, the maintenance and machine information collection unit 23 stores the maintenance information in the maintenance information storage unit 25.

The state feature amount calculation unit 30 calculates the state feature amounts for each image forming apparatus 12, each type of monitoring parameter, and each predetermined unit for the period ΔT₁, based on the maintenance information and the machine information, thereby calculating the state feature amount groups A for each image forming apparatus 12.

In the first exemplary embodiment, an example of the state feature amount B is the standard deviation of the monitoring parameter for each predetermined unit. However, the invention is not limited thereto. The state feature amount may be, for example, the variance value of the monitoring parameter for each predetermined unit or a correlation coefficient between the monitoring parameters for a predetermined unit. In addition, the state feature amount may be available as long as the state feature amount is statistics indicating the degree of variation in the monitoring parameter for the period ΔT₁.

In the first exemplary embodiment, an example of the predetermined unit is one job. However, the invention is not limited thereto. For example, the predetermined unit may be several jobs, one day, or several days. In addition, the predetermined unit may be available, as long as the predetermined unit is a period shorter than the period ΔT₁.

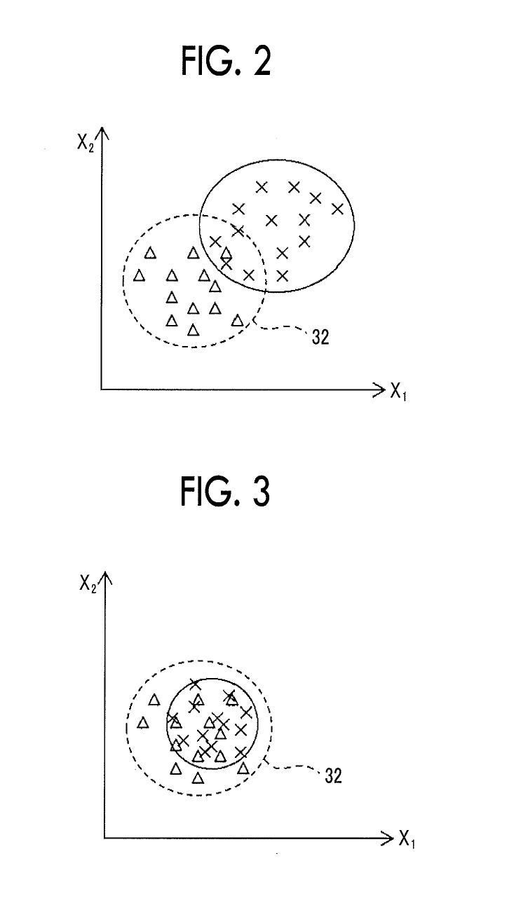

For example, as illustrated in FIGS. 2 and 3, the classification unit 22 generates a reference space 32, using the state feature amount groups B which are calculated for each of the plural image forming apparatuses 12 by the state feature amount calculation unit 30. The reference space 32 is required to calculate the Mahalanobis distance, which will be described below, and is, for example, a feature amount space for a variation in each monitoring parameter for the period ΔT₁. In the examples illustrated in FIGS. 2 and 3, the reference space 32 is defined by state feature amounts X₁ and X₂. However, this is an illustrative example. The reference space 32 may be defined by plural state feature amount groups B.

In the example illustrated in FIG. 2, the state feature amount group B (solid frame) related to a machine A is not included in the reference space 32 (dashed frame). This means that the degree of variation in the state feature amount of the machine A is large. In contrast, in the example illustrated in FIG. 3, the state feature amount group B (solid frame) related to the machine A is included in the reference space 32 (dashed frame). This means that the degree of variation in the state feature amount of the machine A is small. The variation in the state feature amount is specified from the Mahalanobis distance between the reference space 32 and the state feature amount group B for each image forming apparatus 12.

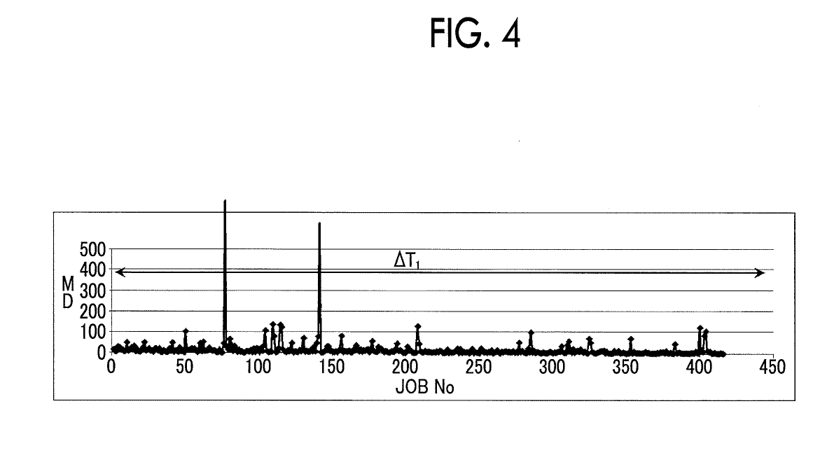

The classification unit 22 calculates the Mahalanobis distance between the reference space and the state feature amount group B which is calculated for each image forming apparatus 12 by the state feature amount calculation unit 30 in the range of the period ΔT₁ for each predetermined unit. FIG. 4 illustrates the Mahalanobis distance (MD) which is calculated for each job in the range of the period ΔT₁. Hereinafter, for convenience of explanation, the Mahalanobis distance which is calculated for each predetermined unit is referred to as a “unit Mahalanobis distance”.

The classification unit 22 calculates the average of the unit Mahalanobis distances for each image forming apparatus 12 for the period ΔT₁. Hereinafter, the average of the unit Mahalanobis distances for the period ΔT₁ is referred to as a “average Mahalanobis distance”.

The classification unit 22 classifies the average Mahalanobis distances of the plural image forming apparatuses 12 into a predetermined number of groups to classify the plural image forming apparatuses 12. For example, the classification unit 22 calculates the median of plural average Mahalanobis distances and classifies the image forming apparatuses 12 into the image forming apparatus 12 with a average Mahalanobis distance less than the median and the image forming apparatus 12 with a average Mahalanobis distance equal to or greater than the median.

In the first exemplary embodiment, the example in which the median of the plural average Mahalanobis distances is calculated as a classification condition has been described. However, the invention is not limited thereto. For example, the average of the average Mahalanobis distances may be used as the classification condition. When plural image forming apparatuses 12 are classified into three or more classes, a clustering method, such as a k-means method, may be used for the classification. In addition, the average Mahalanobis distance and the standard deviation of the Mahalanobis distances of the plural image forming apparatuses 12 may be calculated and the classification condition may be calculated along two axes. In this case, for example, the median of each of the average Mahalanobis distance and the standard deviation of the Mahalanobis distance may be used as the classification condition and the image forming apparatuses 12 may be classified into four types.

The calculation unit 24 includes a prediction model generation unit 34 and a probability calculation unit 36. The prediction model generation unit 34 generates, as a prediction model, the frequency distribution of each of the state feature amounts for a period ΔT₂ and a period ΔT₃ for each of the classes classified by the classification unit 22, using the state feature amount group A calculated by the state feature amount calculation unit 30.

Here, the period ΔT₂ indicates a period for which a failure has occurred in the image forming apparatus 12. For example, the period ΔT₂ indicates a designated period (a designated period from the date when a failure has occurred as the initial date in reckoning) before the date and time when a failure has occurred in the image forming apparatus 12. The period ΔT₃ indicates a period for which no failure has occurred in the image forming apparatus 12. For example, the period ΔT₃ indicates a designated period other than the period ΔT₂. In addition, a designated period in the period ΔT₂ is shorter than the period ΔT₁. In the first exemplary embodiment, the designated period is five days. Hereinafter, for convenience of explanation, the frequency distribution of the state feature amount for the period ΔT₃ is referred to as a “frequency distribution for a normal period” and the frequency distribution of the state feature amount for the period ΔT₂ is referred to as a “frequency distribution for an abnormal period”.

The probability calculation unit 36 calculates the probability of a failure occurring in the image forming apparatus to be subjected to the failure prediction process, based on a specific prediction model generated by the prediction model generation unit 34, using a Naive Bayes method. Here, the specific prediction model indicates a frequency distribution which is generated by the prediction model generation unit 34 as a prediction model related to the image forming apparatus 12 included in a specific class among the classes classified by the classification unit 22. In addition, the specific class indicates a class corresponding to the degree of separation between the reference space and the state feature amount group B, which is calculated for the image forming apparatus to be subjected to the failure prediction process in the range of the period ΔT₁ by the state feature amount calculation unit 30, among the classes classified by the classification unit 22.

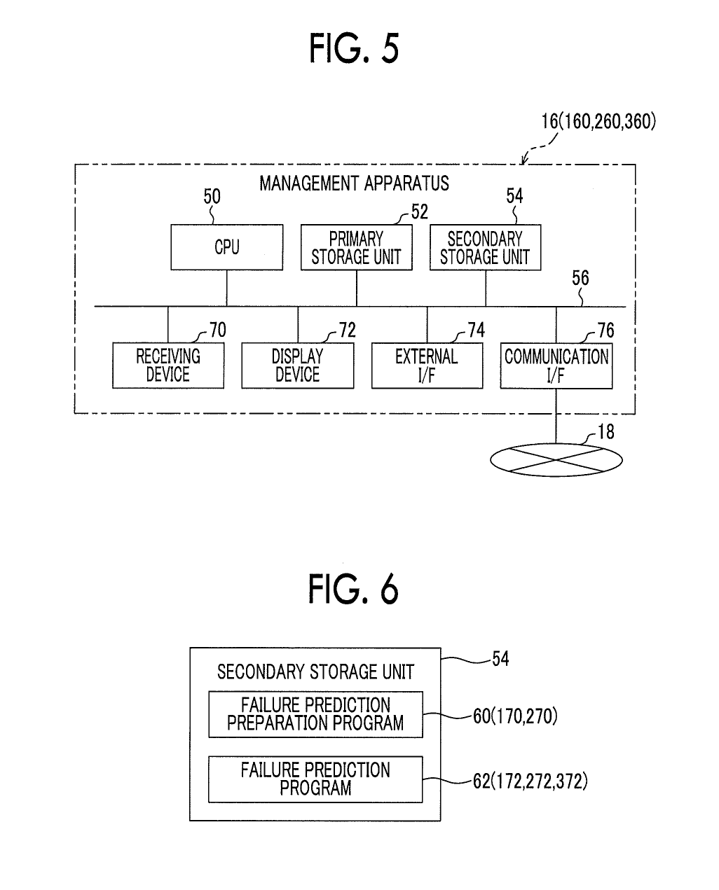

For example, as illustrated in FIG. 5, the management apparatus 16 includes a central processing unit (CPU) 50, a primary storage unit 52, and a secondary storage unit 54. The primary storage unit 52 is a volatile memory (for example, a random access memory (RAM)) which is used as a work area when various kinds of programs are executed. The secondary storage unit 54 is a non-volatile memory (for example, a flash memory or a hard disk drive (HDD)) which stores, for example, a control program for controlling the operation of the management apparatus 16 or various kinds of parameters in advance. The CPU 50, the primary storage unit 52, and the secondary storage unit 54 are connected to each other through a bus 56.

For example, as illustrated in FIG. 6, the secondary storage unit 54 includes a failure prediction preparation program 60 and a failure prediction program 62. Hereinafter, for convenience of explanation, when the failure prediction preparation program 60 and the failure prediction program 62 do not need to be distinguished from each other, they are referred to as a “program” without a reference numeral.

The CPU 50 reads the program from the secondary storage unit 54, develops the program in the primary storage unit 52, executes the program, and operates as the acquisition unit 20, the classification unit 22, the calculation unit 24, and the notification unit 26. In addition, the acquisition unit 20 is implemented by the CPU 50 and the secondary storage unit 54 is used as the maintenance information storage unit 25 and the machine information storage unit 28.

Here, the example in which the program is read from the secondary storage unit 54 has been described. However, the program is not necessarily stored in the secondary storage unit 54 at the beginning. For example, the program may be stored in any portable storage medium, such as a solid state drive (SSD), a DVD disk, an IC card, a magneto-optical disk, or a CD-ROM which is connected to the management apparatus 16. Then, the CPU 50 may acquire the program from the portable storage medium and execute the program. In addition, the program may be stored in, for example, a storage unit of another computer or another server apparatus which is connected to the management apparatus 16 through the communication network 18 and the CPU 50 may acquire the program from, for example, another computer or another server apparatus and execute the program.

The secondary storage unit 54 has a prediction model storage area (not illustrated). The CPU 50 overwrites the prediction model to the prediction model storage area and saves the prediction model. When the prediction model is overwritten and saved, the content stored in the prediction model storage area is updated to the latest prediction model.

For example, as illustrated in FIG. 5, the management apparatus 16 includes a receiving device 70 and a display device 72. The receiving device 70 includes, for example, a keyboard, a mouse, and a touch panel and receives various kinds of information from the user. The receiving device 70 is connected to the bus 56 and the CPU 50 acquires various kinds of information received by the receiving device 70. The display device 72 is, for example, a liquid crystal display and the touch panel of the receiving device 70 overlaps a display surface of the liquid crystal display. The display device 72 is connected to the bus 56 and displays various kinds of information under the control of the CPU 50.

The management apparatus 16 includes an external interface (I/F) 74. The external I/F 74 is connected to the bus 56. The external I/F 74 is connected to an external device, such as a USB memory or an external hard disk device, and receives and transmits various kinds of information between the external device and the CPU 50.

The management apparatus 16 includes a communication I/F 76. The communication I/F 76 is connected to the bus 56. The communication I/F 76 is connected to the communication network 18 and transmits and receives various kinds of information between the CPU 50, and the image forming apparatus 12 and the terminal apparatus 14.

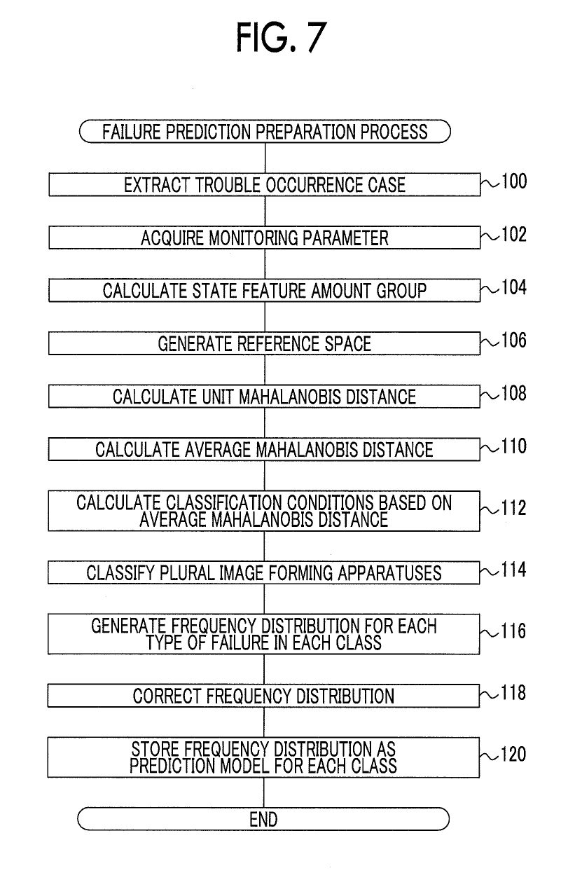

Next, a failure prediction preparation process which is performed by executing the failure prediction preparation program 60 by the CPU 50 when the start condition (preparation start condition) of the failure prediction preparation process is satisfied will be described with reference to FIG. 7. The failure prediction preparation process indicates a preparation process in a stage before the failure prediction process for predicting the occurrence of a failure in the image forming apparatus to be subjected to the failure prediction process is performed. The preparation start condition indicates the condition at which the terminal apparatus 14 transmits a preparation start instruction signal indicating an instruction to start the failure prediction preparation process and the management apparatus 16 receives the preparation start instruction signal. However, the invention is not limited thereto. For example, the preparation start condition may be the condition at which the receiving device 70 receives the instruction to start the failure prediction preparation process.

In the failure prediction preparation process illustrated in FIG. 7, first, in Step 100, the state feature amount calculation unit 30 extracts the maintenance information as the trouble occurrence case from the maintenance information storage unit 25.

Then, in Step 102, the state feature amount calculation unit 30 extracts the machine information corresponding to the maintenance information extracted in Step 100 from the machine information storage unit 28.

Then, the state feature amount calculation unit 30 acquires, from the extracted machine information, the monitoring parameter for each predetermined unit in the range of the period ΔT₁ for each preset type of monitoring parameter which has been associated with the type of failure occurred in the image forming apparatus 12. The preset type of monitoring parameter indicates the type of monitoring parameter which contributes to predicting the occurrence of a failure. For example, in Step 102, when image quality deteriorates due to a change in density, for example, a charged voltage, a developing bias, and the amount of laser light are acquired as the monitoring parameters.

Then, in Step 104, the state feature amount calculation unit 30 calculates the state feature amount groups A based on the monitoring parameters, which have been acquired for each predetermined unit in Step 102, for each image forming apparatus. The type of monitoring parameter required to calculate the state feature amount group A in Step 104 is predetermined for each type of failure.

Then, in Step 106, the classification unit 22 generates the reference space from the state feature amount group B among the state feature amount groups A calculated in Step 104.

Then, in Step 108, the classification unit 22 calculates the unit Mahalanobis distances for each image forming apparatus 12, using the reference space generated in Step 106.

Then, in Step 110, the classification unit 22 calculates the average Mahalanobis distances for each image forming apparatus 12 from the unit Mahalanobis distances calculated in Step 108.

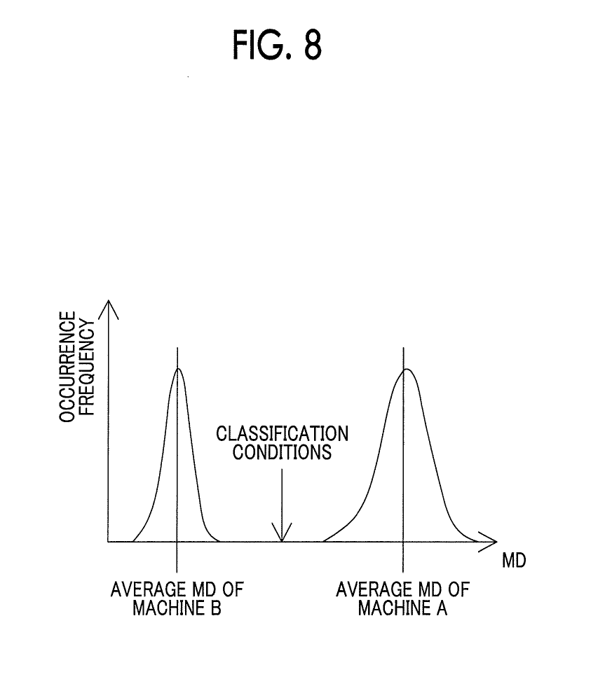

Then, in Step 112, the classification unit 22 calculates the classification condition based on the average Mahalanobis distances calculated in Step 110. That is, in Step 112, for example, as illustrated in FIG. 8, the median of the plural average Mahalanobis distances is calculated as the classification condition.

Then, in Step 114, the classification unit 22 classifies the plural image forming apparatuses 12 according to the classification condition calculated in Step 112. In Step 114, for example, the plural image forming apparatuses 12 are classified into the image forming apparatus 12 with a average Mahalanobis distance that is less than the median of the plural average Mahalanobis distances and the image forming apparatus 12 with a average Mahalanobis distance that is equal to or greater than the median.

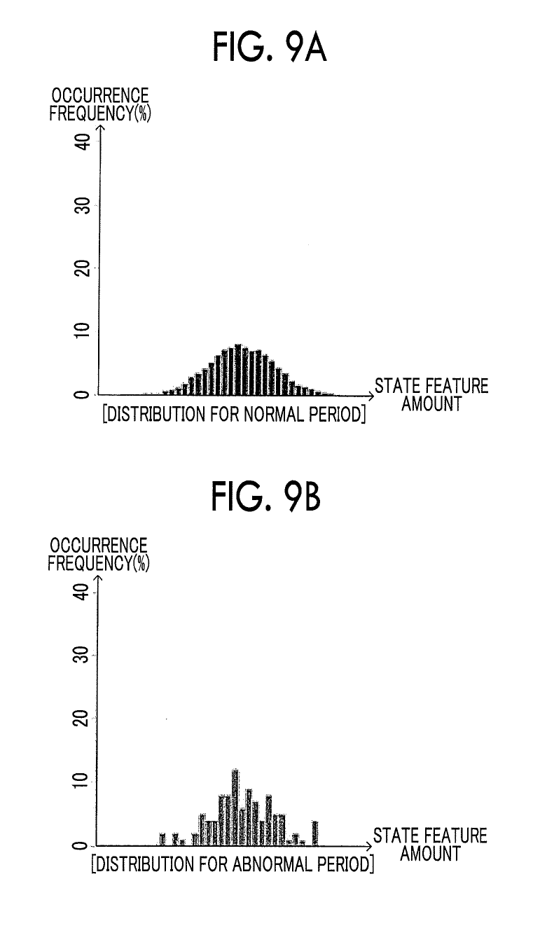

Then, in Step 116, the prediction model generation unit 34 classifies the state feature amounts included in the state feature amount group A calculated in Step 104 into the state feature amount for the period ΔT₂ and the state feature amount for the period ΔT₃ for each of the classes classified in Step 114. Then, for example, as illustrated in FIGS. 9A and 9B, the prediction model generation unit 34 generates the frequency distribution for the normal period and the frequency distribution for the abnormal period for each of plural types of predetermined state feature amounts corresponding to each type of failure in each of the classes classified in Step 114.

Then, in Step 118, the prediction model generation unit 34 normalizes frequency values in the frequency distribution for the normal period and the frequency distribution for the abnormal period, which have been generated in Step 116, to correct the frequency distribution for the normal period and the frequency distribution for the abnormal period.

Here, the example in which the frequency values are normalized to correct the frequency distributions has been described. However, the invention is not limited thereto. For example, in order to correct a variation in the state feature amount between the image forming apparatuses 12, the average and standard deviation of the state feature amounts for each image forming apparatus 12 may be calculated and the state feature amounts may be normalized to generate the frequency distributions.

Then, in Step 120, for each of the classes classified in Step 114, the prediction model generation unit 34 overwrites the frequency distribution for the normal period and the frequency distribution for the abnormal period, which have been corrected in Step 118, as the prediction model to the prediction model storage area of the secondary storage unit 54 and saves the frequency distributions. Then, the failure prediction preparation process ends.

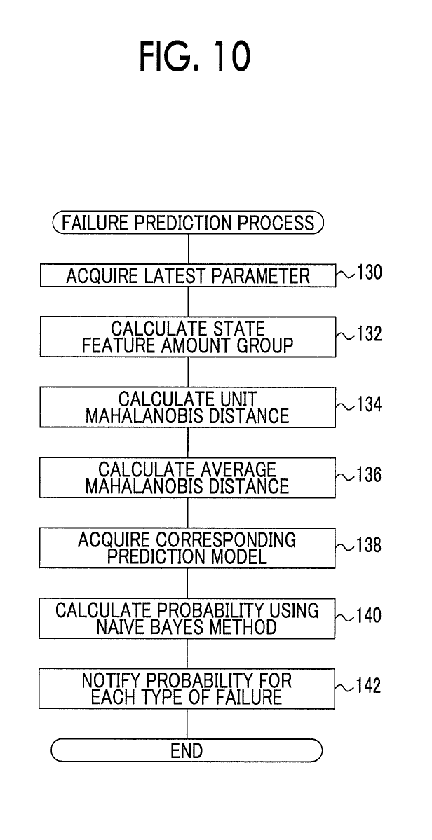

Next, the failure prediction process which is performed by the CPU 50 by executing the failure prediction program 62 by the CPU 50 when the prediction start condition of the failure prediction process for predicting the occurrence of a failure in the image forming apparatus to be subjected to the failure prediction process is satisfied will be described with reference to FIG. 10. The prediction start condition indicates the condition at which the terminal apparatus 14 transmits a prediction start instruction signal indicating an instruction to start the failure prediction process and the management apparatus 16 receives the prediction start instruction signal. However, the invention is not limited thereto. For example, the prediction start condition may be the condition at which the receiving device 70 receives the instruction to start the failure prediction process.

In the failure prediction process illustrated in FIG. 10, first, in Step 130, the state feature amount calculation unit 30 extracts, from the machine information storage unit 28, the latest machine information related to the image forming apparatus to be subjected to the failure prediction process (here, for example, the machine information within the period ΔT₁ at and before the present time). Then, the state feature amount calculation unit 30 acquires, from the extracted machine information, the monitoring parameter (the latest parameter) for each predetermined unit within the period ΔT₁ for each preset type of monitoring parameter which has been associated with the type of failure in the image forming apparatus to be subjected to the failure prediction process.

Then, in Step 132, the state feature amount calculation unit 30 calculates the state feature amount group A based on the monitoring parameter, which has been acquired for each predetermined unit in Step 130, for each image forming apparatus. The type of monitoring parameter required to calculate the state feature amount group A in Step 132 is predetermined for each type of failure.

Then, in Step 134, the probability calculation unit 36 calculates the unit Mahalanobis distance for the state feature amount B among the state feature amount groups A calculated in Step 132, using the reference space generated in Step 106 of the failure prediction preparation process.

Then, in Step 136, the probability calculation unit 36 calculates the average Mahalanobis distance for the unit Mahalanobis distances calculated in Step 134. In the first exemplary embodiment, since the median of the average Mahalanobis distance is used as the classification condition, the average Mahalanobis distance is calculated in Step 136. However, when the median of the standard deviation of the Mahalanobis distance is used as the classification condition, the standard deviation of the Mahalanobis distance is calculated in Step 136.

Then, in Step 138, the probability calculation unit 36 acquires, from the prediction model storage area of the secondary storage unit 54, a prediction model corresponding to the class which corresponds to the average Mahalanobis distance calculated in Step 136 among the classes classified in Step 114 of the failure prediction preparation process.

Then, in Step 140, the probability calculation unit 36 calculates the probability of a failure occurring in the image forming apparatus to be subjected to the failure prediction process in the near future for each type of failure, based on the state feature amount group A calculated in Step 132 and the prediction model acquired in Step 138, using the Naive Bayes method.

That is, in Step 140, the probability of a failure T occurring in the image forming apparatus to be subjected to the failure prediction process is calculated by the following Expression (1). Expression (1) is established on the assumption that there is no correlation between the state feature amounts. In Expression (1), T is the type of a failure, the probability of which is to be calculated. In addition, xᵢ is the value of each of n types of state feature amounts Xᵢ (1≦i≦n) related to the failure T which are calculated based on m types of monitoring parameters Pⱼ (1≦j≦m) included in the latest machine information of the image forming apparatus in which the failure T is predicted to occur.

$$\begin{matrix}[ Expression 1 ] & \\ P ( ( T - yes ) \vert {x}_{1} , {x}_{2} , … , {x}_{n} ) = \begin{matrix}P ( T - yes ) \cdot {\prod }_{i = 1}^{n} P ( {x}_{i} \vert ( T = yes ) ) \\ P ( T - yes ) \cdot {\prod }_{i = 1}^{n} P ( {x}_{i} \vert ( T = yes ) ) + P ( T = no ) \cdot {\prod }_{i = 1}^{n} P ( {x}_{i} \vert ( T = no ) )\end{matrix} & ( 1 )\end{matrix}$$

In Expression 1, P(T=yes) is the probability (prior probability) of the failure T occurring, P(T=no) is the probability (prior probability) of the failure T not occurring, and P(T=yes)+P(T=no)=1 is established.

In addition, P(xᵢ|(T=yes)) is the probability that the value of an i-th state feature amount Xᵢ will be xᵢ when the failure T occurs and the probability of xᵢ in a probability distribution for determining the type of failure (a failure occurs) for the state feature amount Xᵢ corresponding to the failure T is used.

Furthermore, P(xᵢ|(T=no)) is the probability that the value of the i-th state feature amount Xᵢ will be xᵢ when the failure T does not occur and the probability of xᵢ in the probability distribution for determining the type of failure (no failure occurs) for the state feature amount Xᵢ corresponding to the failure T is used.

That is, the probability calculation unit 36 calculates the probability [P((T=yes)|x₁, x₂, . . . , xₙ)] of the failure T occurring in the image forming apparatus to be subjected to the failure prediction process from [P(T=yes)·ΠP(T=yes))] and [P(T=no)·ΠP(xᵢ|(T=no))] using Expression (1).

Here, [P(T=yes)·P(T=yes))] indicates a value obtained by multiplying the probability (prior probability) of the failure T occurring by the probability of obtaining a combination (x₁, x₂, . . . , xₙ) of the values of n types of state feature amounts Xᵢ (1≦i≦n) when the failure T occurs.

In addition, [P(T=no)·ΠP(xᵢ|(T=no))] indicates a value obtained by multiplying the probability (prior probability) of the failure T not occurring and the probability of obtaining a combination (x₁, x₂, . . . , xₙ) of the values of n types of state feature amounts Xᵢ (1≦i≦n) when the failure T does not occur.

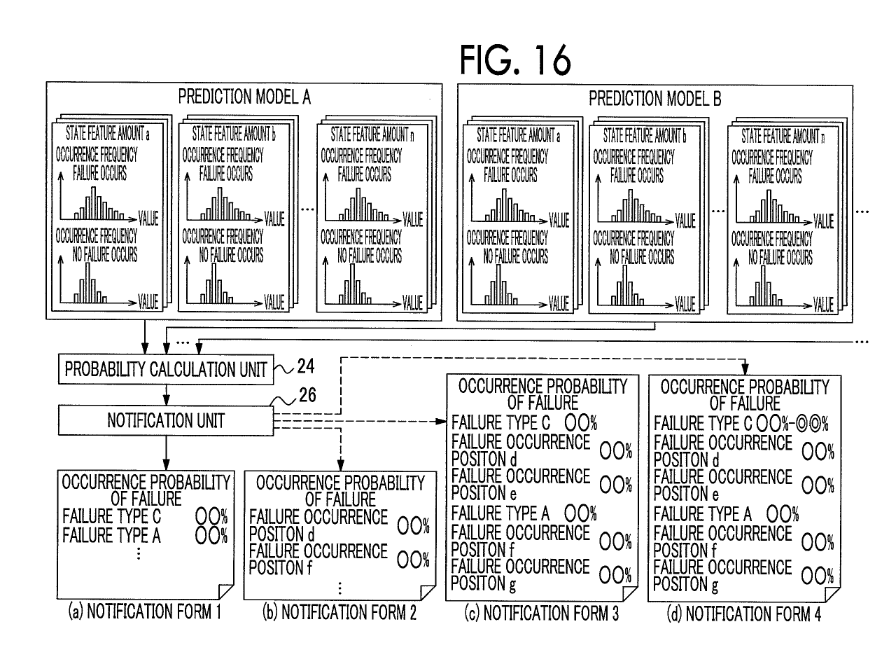

Then, in Step 142, the notification unit 26 notifies the probability which has been calculated for each type of failure by the probability calculation unit 36. Then, the failure prediction process ends. The probability is displayed on at least one of the display device 72 and the display of the terminal apparatus 14 to notify the probability. In addition, the notification unit 26 may notify all of the probabilities calculated by the probability calculation unit 36. However, the invention is not limited thereto. The notification unit 26 may notify a predetermined probability (for example, 80%) or more. In addition, when the probability is notified, it is preferable that the probability is notified in descending order. In addition, for example, as illustrated in (a) of FIG. 16, the process in Step 142 is performed to notify the probability for each type of failure in the form of a list and the probability for each type of failure is displayed in descending order.

### Second Exemplary Embodiment

In the first exemplary embodiment, the example in which the probability is calculated for each type of failure has been described. However, in a second exemplary embodiment, a case in which probability is calculated for each failure occurrence position will be described. In the second exemplary embodiment, the same components as those in the first exemplary embodiment are denoted by the same reference numerals and the description thereof will not be repeated.

For example, as illustrated in FIG. 1, a failure prediction system 200 according to the second exemplary embodiment differs from the failure prediction system 10 according to the first exemplary embodiment in that it includes a management apparatus 160 instead of the management apparatus 16. In addition, for example, as illustrated in FIG. 6, the management apparatus 160 differs from the management apparatus 16 in that the secondary storage unit 54 stores a failure prediction preparation program 170 instead of the failure prediction preparation program 60. Furthermore, for example, as illustrated in FIG. 6, the management apparatus 160 differs from the management apparatus 16 in that the secondary storage unit 54 stores a failure prediction program 172 instead of the failure prediction program 62.

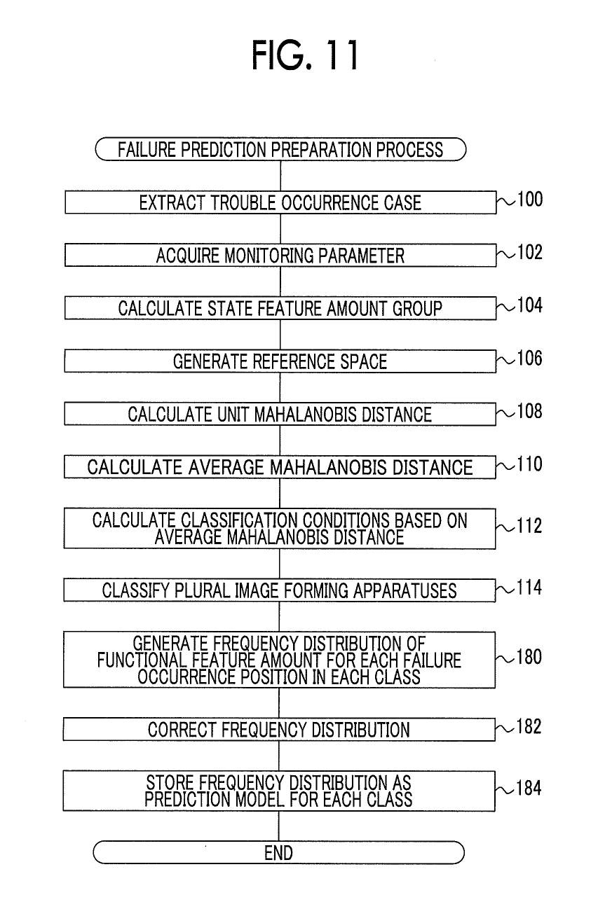

Next, a failure prediction preparation process according to the second exemplary embodiment which is performed by the CPU 50 by executing the failure prediction preparation program 170 by the CPU 50 when a condition (preparation start condition) for starting the preparation of the failure prediction preparation process is satisfied will be described with reference to FIG. 11. The failure prediction preparation process according to the second exemplary embodiment differs from the failure prediction preparation process according to the first exemplary embodiment in that it includes Steps 180, 182, and 184 instead of Steps 116, 118, and 120. Hereinafter, the steps in which the same processes as those in the steps included in the flowchart illustrated in FIG. 7 are performed are denoted by the same step numbers as those in FIG. 7 and the description thereof will not be repeated.

In the failure prediction preparation process illustrated in FIG. 11, in Step 180, the prediction model generation unit 34 classifies the state feature amounts included in the state feature amount group A calculated in Step 104 into a state feature amount for a period ΔT₂ and a state feature amount for a period ΔT₃ for each of the classes classified in Step 114. Then, the prediction model generation unit 34 generates the frequency distributions of each of plural types of predetermined state feature amounts, which correspond to the failure occurrence positions of plural image forming apparatuses 12, for a normal period and an abnormal period for each failure occurrence position in each of the classes classified in Step 114.

Then, in Step 182, the prediction model generation unit 34 normalizes frequency values in the frequency distribution for the normal period and the frequency distribution for the abnormal period, which have been generated in Step 180, to correct the frequency distribution for the normal period and the frequency distribution for the abnormal period.

Then, in Step 184, the prediction model generation unit 34 overwrites the frequency distribution for the normal period and the frequency distribution for the abnormal period, which have been corrected in Step 182, as a prediction model to the prediction model storage area of the secondary storage unit 54 and saves the frequency distributions, for each of the classes classified in Step 114. Then, the failure prediction preparation process ends.

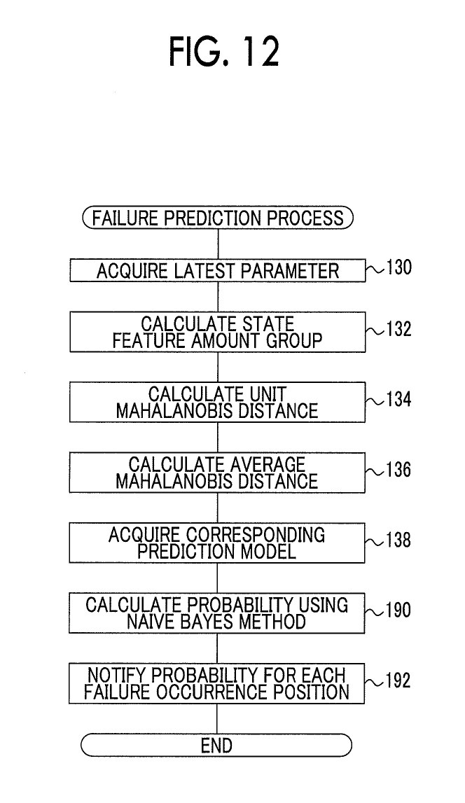

Then, a failure prediction process which is performed by the CPU 50 by executing the failure prediction program 172 by the CPU 50 when the prediction start condition of the failure prediction process for predicting the occurrence of a failure in the image forming apparatus to be subjected to failure prediction process is satisfied will be described with reference to FIG. 12. The failure prediction process according to the second exemplary embodiment differs from the failure prediction process according to the first exemplary embodiment in that it includes Steps 190 and 192 instead of Steps 140 and 142. Hereinafter, the steps in which the same processes as those in the steps included in the flowchart illustrated in FIG. 10 are performed are denoted by the same step numbers as those in FIG. 10 and the description thereof will not be repeated.

In the failure prediction process illustrated in FIG. 12, in Step 190, the probability calculation unit 36 calculates the probability of a failure occurring in the image forming apparatus to be subjected to the failure prediction process in the near future for each failure occurrence position, based on the state feature amount group A calculated in Step 132 and the prediction model acquired in Step 138, using the Naive Bayes method.

That is, in Step 190, the probability of a failure T occurring in the image forming apparatus to be subjected to the failure prediction process is calculated by Expression (1). In addition, Expression (1) is established on the assumption that there is no correlation between the state feature amounts. In Expression (1), T is a failure occurrence position where the probability of a failure occurring is calculated. In addition, xᵢ is the value of each of n types of state feature amounts Xᵢ (1≦i≦n) related to the failure T which are calculated based on m types of monitoring parameters Pⱼ (1≦j≦m) included in the latest machine information of the image forming apparatus in which the failure T is predicted to occur.

In Step 192, the notification unit 26 notifies the probability which has been calculated for each failure occurrence position by the probability calculation unit 36. Then, the failure prediction process ends. In addition, for example, as illustrated in (b) of FIG. 16, the process in Step 192 is performed to notify the probability for each failure occurrence position in the form of a list and the probability for each failure occurrence position is displayed in descending order.

### Third Exemplary Embodiment

In the first exemplary embodiment, the case in which the probability is calculated for each type of failure has been described. However, in a third exemplary embodiment, a case in which probability is calculated for each type of failure and each failure occurrence position will be described. In the third exemplary embodiment, the same components as those in the first and second exemplary embodiments are denoted by the same reference numerals and the description thereof will not be repeated.

For example, as illustrated in FIG. 1, a failure prediction system 300 according to the third exemplary embodiment differs from the failure prediction system 10 according to the first exemplary embodiment in that it includes a management apparatus 260 instead of the management apparatus 16. In addition, for example, as illustrated in FIG. 6, the management apparatus 260 differs from the management apparatus 16 in that the secondary storage unit 54 stores a failure prediction preparation program 270 instead of the failure prediction preparation program 60. Furthermore, for example, as illustrated in FIG. 6, the management apparatus 260 differs from the management apparatus 16 in that the secondary storage unit 54 stores a failure prediction program 272 instead of the failure prediction program 62.

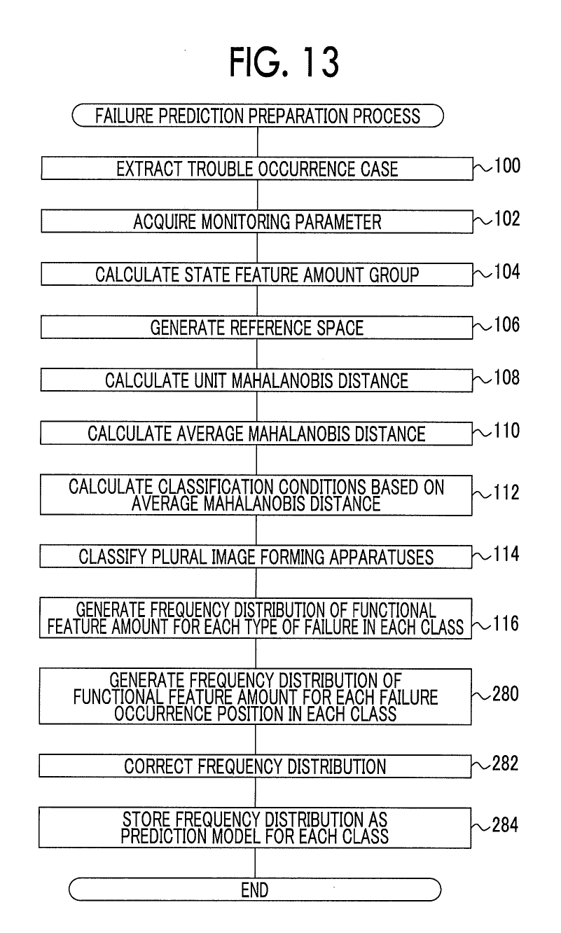

Next, a failure prediction preparation process according to the third exemplary embodiment which is performed by the CPU 50 by executing the failure prediction preparation program 270 by the CPU 50 when a condition (preparation start condition) for starting the preparation of the failure prediction preparation process is satisfied will be described with reference to FIG. 13. The failure prediction preparation process according to the third exemplary embodiment differs from the failure prediction preparation process according to the first exemplary embodiment in that it includes Steps 280, 282, and 284 instead of Steps 118 and 120. Hereinafter, the steps in which the same processes as those in the steps included in the flowchart illustrated in FIG. 7 are performed are denoted by the same step numbers as those in FIG. 7 and the description thereof will not be repeated.

In the failure prediction preparation process illustrated in FIG. 13, in Step 280, the prediction model generation unit 34 classifies the state feature amounts included in the state feature amount group A calculated in Step 104 into a state feature amount for a period ΔT₂ and a state feature amount for a period ΔT₃ for each of the classes classified in Step 114. Then, the prediction model generation unit 34 generates the frequency distributions of each of plural types of predetermined state feature amounts, which correspond to the failure occurrence positions of plural image forming apparatuses 12, for a normal period and an abnormal period for each failure occurrence position in each of the classes classified in Step 114.

Then, in Step 282, the prediction model generation unit normalizes the frequency values in the frequency distribution for the normal period and the frequency distribution for the abnormal period, which have been generated in Steps 116 and 280, to correct the frequency distribution for the normal period and the frequency distribution for the abnormal period.

Then, in Step 284, the prediction model generation unit 34 overwrites the frequency distribution for the normal period and the frequency distribution for the abnormal period, which have been corrected in Step 282, as a prediction model to the prediction model storage area of the secondary storage unit 54 and saves the frequency distributions, for each of the classes classified in Step 114. Then, the failure prediction preparation process ends.

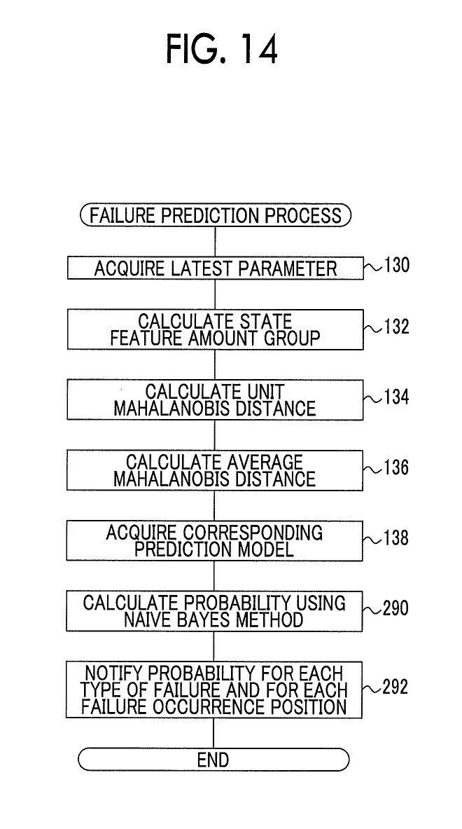

Then, a failure prediction process which is performed by the CPU 50 by executing the failure prediction program 272 by the CPU 50 when the prediction start condition of the failure prediction process for predicting the occurrence of a failure in the image forming apparatus to be subjected to failure prediction process is satisfied will be described with reference to FIG. 14. The failure prediction process according to the third exemplary embodiment differs from the failure prediction process according to the first exemplary embodiment in that it includes Steps 290 and 292 instead of Steps 140 and 142. Hereinafter, the steps in which the same processes as those in the steps included in the flowchart illustrated in FIG. 10 are performed are denoted by the same step numbers as those in FIG. 10 and the description thereof will not be repeated.

In the failure prediction process illustrated in FIG. 14, in Step 290, the probability calculation unit 36 calculates the probability of a failure occurring in the image forming apparatus to be subjected to the failure prediction process in the near future for each type of failure, based on the state feature amount group A calculated in Step 132 and the prediction model acquired in Step 138, using the Naive Bayes method. In addition, the probability calculation unit 36 calculates the probability of a failure occurring in the image forming apparatus to be subjected to the failure prediction process in the near future for each failure occurrence position, based on the state feature amount group A calculated in Step 132 and the prediction model acquired in Step 138, using the Naive Bayes method.

Then, in Step 292, the notification unit 26 classifies the probabilities which have been calculated for each type of failure by the probability calculation unit 36 and the probabilities which have been calculated for each failure occurrence position by the probability calculation unit 36 according to the type of failure and notifies the probabilities. Then, the failure prediction process ends. When the probabilities for each failure occurrence position are classified according to the type of failure, for example, a correspondence table in which the type of failure and the failure occurrence position are associated with each other may be prepared in advance and the classification may be performed according to the correspondence table.

For example, as illustrated in (c) of FIG. 16, when the process in Step 292 is performed, the probabilities for each type of failure and the probabilities for each failure occurrence position are classified according to the type of failure and are notified in the form of a list. In addition, the probabilities for each type of failure are displayed in descending order and the probabilities for each failure occurrence position corresponding to each type of failure are displayed in descending order.

### Fourth Exemplary Embodiment

In the third exemplary embodiment, the example in which the probability for each type of failure is not corrected has been described. However, in a fourth exemplary embodiment, a case in which probability for a specific type of failure among plural types of failures is corrected will be described. In the fourth exemplary embodiment, the same components as those in the first to third exemplary embodiments are denoted by the same reference numerals and the description thereof will not be repeated.

For example, as illustrated in FIG. 1, a failure prediction system 400 according to the fourth exemplary embodiment differs from the failure prediction system 300 according to the third exemplary embodiment in that it includes a management apparatus 360 instead of the management apparatus 260. In addition, for example, as illustrated in FIG. 6, the management apparatus 360 differs from the management apparatus 260 in that the secondary storage unit 54 stores a failure prediction program 372 instead of the failure prediction program 272.

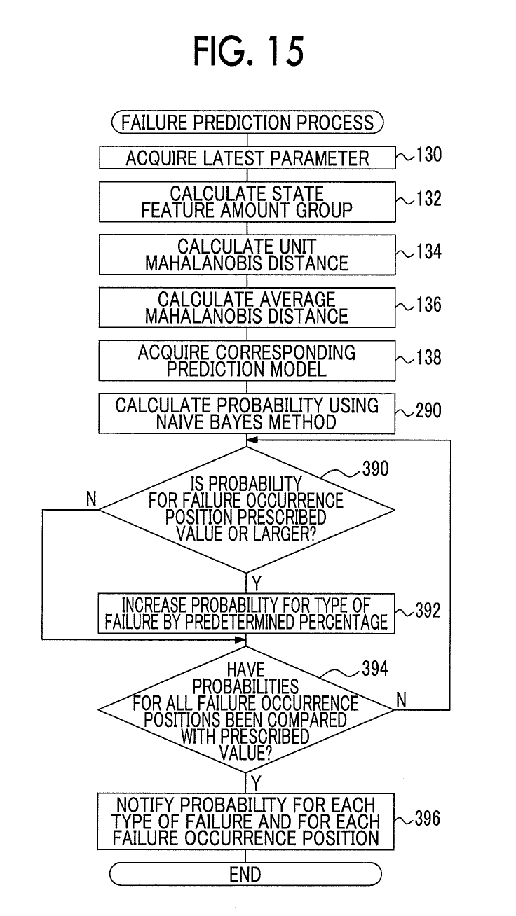

Next, a failure prediction process which is performed by the CPU 50 by executing the failure prediction program 372 by the CPU 50 when the prediction start condition of the failure prediction process for predicting the occurrence of a failure in the image forming apparatus to be subjected to the failure prediction process is satisfied will be described with reference to FIG. 15. The failure prediction process according to the fourth exemplary embodiment differs from the failure prediction process according to the third exemplary embodiment in that it includes Step 396 instead of Step 292 and includes Steps 390, 392, and 394 between Steps 290 and 396. Hereinafter, the steps in which the same processes as those in the steps included in the flowchart illustrated in FIG. 14 are performed are denoted by the same step numbers as those in FIG. 14 and the description thereof will not be repeated.

In the failure prediction process illustrated in FIG. 15, in Step 390, the probability calculation unit 36 determines whether one probability which has not been a determination target in Step 390 among the probabilities calculated for each failure occurrence position is equal to or greater than a prescribed value. When it is determined in Step 390 that one probability which has not been a determination target in Step 390 among the probabilities calculated for each failure occurrence position is equal to or greater than the prescribed value, that is, when the determination result is “Yes”, the process proceeds to Step 392. When it is determined in Step 390 that one probability which has not been a determination target in Step 390 among the probabilities calculated for each failure occurrence position is less than the prescribed value, that is, when the determination result is “No”, the process proceeds to Step 394.

In Step 392, the probability calculation unit 36 specifies the type of failure which mainly occurs at the failure occurrence position where probability is equal to or greater than the prescribed value and performs correction for increasing the probability for the specified type of failure by a predetermined percentage. In addition, the type of failure may be specified according to, for example, a correspondence table in which the type of failure and the failure occurrence position are associated with each other in advance.

In Step 394, the probability calculation unit 36 determines whether all of the probabilities calculated for each failure occurrence position have been compared with the prescribed value. When it is determined in Step 394 that all of the probabilities calculated for each failure occurrence position have not been compared with the prescribed value, that is, when the determination result is “No”, the process proceeds to Step 390. When it is determined in Step 394 that all of the probabilities calculated for each failure occurrence position have been compared with the prescribed value, that is, when the determination result is “Yes”, the process proceeds to Step 396.

In Step 396, the notification unit 26 classifies the probabilities before and after correction which have been calculated for each type of failure by the probability calculation unit 36 and the probabilities which have been calculated for each failure occurrence position by the probability calculation unit 36 according to the type of failure and notifies the probabilities. Then, the failure prediction process ends. When the probabilities for each failure occurrence position are classified according to the type of failure, for example, a correspondence table in which the type of failure and the failure occurrence position are associated with each other may be prepared in advance and the classification may be performed according to the correspondence table.

For example, as illustrated in (d) of FIG. 16, when the process in Step 396 is performed, the probabilities before and after correction which have been calculated for each type of failure and the probabilities which have been calculated for each failure occurrence position are classified according to the type of failure and are notified in the form of a list. In addition, the probability for each type of failure is displayed in descending order of the probability after correction and the probability for each failure occurrence position corresponding to each type of failure is displayed in descending order.

The failure prediction preparation process (FIGS. 7, 11, and 13) according to each of the above-described exemplary embodiments is an illustrative example. In addition, the failure prediction process (FIGS. 10, 12, 14, and 15) according to each of the above-described exemplary embodiments is an illustrative example. Therefore, an unnecessary step may be deleted, a new step may be added, or the order of the process may be changed, without departing from the scope and spirit of the invention.

In each of the above-described exemplary embodiments, the example in which the state feature amount calculation unit calculates the state feature amount group A has been described. However, the invention is not limited thereto. For example, the acquisition unit 20 may acquire the state feature amount group which is calculated by an apparatus other than the management apparatus 16.

In each of the above-described exemplary embodiments, the example in which the management apparatus 16 includes the acquisition unit 20, the classification unit 22, and the calculation unit 24 has been described. However, the invention is not limited thereto. For example, the acquisition unit 20, the classification unit 22, and the calculation unit 24 may be distributed and implemented by plural electronic computers. In addition, any one of plural image forming apparatuses 12 connected to the communication network 18 may include at least one of the acquisition unit 20, the classification unit 22, and the calculation unit 24.

In each of the above-described exemplary embodiments, the example in which the state feature amounts and the probabilities are calculated by the corresponding arithmetic expressions has been described. However, the invention is not limited thereto. For example, the state feature amounts and the probabilities may be calculated from a table in which a variable to be substituted into the arithmetic expression is an input and the solution obtained by the arithmetic expression is an output.

In each of the above-described exemplary embodiments, the image forming apparatus 12 is given as an example of the apparatus to be monitored according to the exemplary embodiment of the invention. However, the invention is not limited thereto. For example, the apparatus to be monitored may be a server apparatus or an automated teller machine (ATM) connected to the communication network 18.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A failure prediction apparatus comprising:
an acquisition unit that acquires, from a plurality of apparatuses to be monitored, state feature amount groups which are a plurality of state feature amounts indicating features of an operating state of the apparatuses to be monitored;
a classification unit that classifies the plurality of apparatuses to be monitored for each degree of separation between a reference space which is defined by the plurality of state feature amount groups acquired by the acquisition unit and the state feature amount group of each of the plurality of apparatuses to be monitored; and
a calculation unit that specifies a class which is classified by the classification unit and corresponds to the degree of separation between the reference space and the state feature amount group of an apparatus to be monitored and subjected to a failure prediction process acquired by the acquisition unit for a predetermined period among the plurality of apparatuses to be monitored, and calculates a probability of a failure occurring in the apparatus to be monitored and subjected to the failure prediction process, using the state feature amount group related to the apparatus to be monitor included in the class.

2. The failure prediction apparatus according to claim 1,
wherein the state feature amount used by the classification unit is statistics indicating a degree of variation in a functional physical amount which is unique to a function of the apparatus to be monitored.

3. The failure prediction apparatus according to claim 2,
wherein the degree of separation is defined by a Mahalanobis distance between the reference space and the state feature amount group of each of the plurality of apparatuses to be monitored.

4. The failure prediction apparatus according to claim 3,
wherein the degree of separation is at least one of an average and a standard deviation of the Mahalanobis distance, which is calculated for each predetermined unit, for a specific period.

5. The failure prediction apparatus according to claim 2,
wherein the calculation unit generates a plurality of distributions at the time of a failure, which indicate an occurrence frequency distribution of each of the plurality of state feature amounts when a failure occurs in the apparatus to be monitored, and a plurality of distributions at the time of no failure, which indicate an occurrence frequency distribution of each of the plurality of state feature amounts when no failure occurs in the apparatus to be monitored, based on the state feature amount group related to the apparatus to be monitored which is included in a class corresponding to the degree of separation between the reference space and the state feature amount group of the apparatus to be monitored and subjected to the failure prediction process acquired for the predetermined period, and calculates a probability of a failure occurring in the apparatus to be monitored and subjected to the failure prediction process, using the generated distributions at the time of a failure and the generated distributions at the time of no failure.

6. The failure prediction apparatus according to claim 3,
wherein the calculation unit generates a plurality of distributions at the time of a failure, which indicate an occurrence frequency distribution of each of the plurality of state feature amounts when a failure occurs in the apparatus to be monitored, and a plurality of distributions at the time of no failure, which indicate an occurrence frequency distribution of each of the plurality of state feature amounts when no failure occurs in the apparatus to be monitored, based on the state feature amount group related to the apparatus to be monitored which is included in a class corresponding to the degree of separation between the reference space and the state feature amount group of the apparatus to be monitored and subjected to the failure prediction process acquired for the predetermined period, and calculates a probability of a failure occurring in the apparatus to be monitored and subjected to the failure prediction process, using the generated distributions at the time of a failure and the generated distributions at the time of no failure.

7. The failure prediction apparatus according to claim 4,
wherein the calculation unit generates a plurality of distributions at the time of a failure, which indicate an occurrence frequency distribution of each of the plurality of state feature amounts when a failure occurs in the apparatus to be monitored, and a plurality of distributions at the time of no failure, which indicate an occurrence frequency distribution of each of the plurality of state feature amounts when no failure occurs in the apparatus to be monitored, based on the state feature amount group related to the apparatus to be monitored which is included in a class corresponding to the degree of separation between the reference space and the state feature amount group of the apparatus to be monitored and subjected to the failure prediction process acquired for the predetermined period, and calculates a probability of a failure occurring in the apparatus to be monitored and subjected to the failure prediction process, using the generated distributions at the time of a failure and the generated distributions at the time of no failure.

8. A failure prediction system comprising:
the failure prediction apparatus according to claim 1; and
a plurality of apparatuses to be monitored whose state feature amount groups are acquired by an acquisition unit in the failure prediction apparatus.

9. The failure prediction system according to claim 8,
wherein the state feature amount used by the classification unit of the failure prediction apparatus is statistics indicating a degree of variation in a functional physical amount which is unique to a function of the apparatus to be monitored.

10. The failure prediction system according to claim 9,
wherein the degree of separation of the failure prediction apparatus is defined by a Mahalanobis distance between the reference space and the state feature amount group of each of the plurality of apparatuses to be monitored.

11. The failure prediction system according to claim 10,
wherein the degree of separation of the failure prediction apparatus is at least one of an average and a standard deviation of the Mahalanobis distance, which is calculated for each predetermined unit, for a specific period.

12. The failure prediction system according to claim 9,
wherein the calculation unit of the failure prediction apparatus generates a plurality of distributions at the time of a failure, which indicate an occurrence frequency distribution of each of the plurality of state feature amounts when a failure occurs in the apparatus to be monitored, and a plurality of distributions at the time of no failure, which indicate an occurrence frequency distribution of each of the plurality of state feature amounts when no failure occurs in the apparatus to be monitored, based on the state feature amount group related to the apparatus to be monitored which is included in a class corresponding to the degree of separation between the reference space and the state feature amount group of the apparatus to be monitored and subjected to the failure prediction process acquired for the predetermined period, and calculates a probability of a failure occurring in the apparatus to be monitored and subjected to the failure prediction process, using the generated distributions at the time of a failure and the generated distributions at the time of no failure.

13. The failure prediction system according to claim 8,
wherein the apparatus to be monitored is an image forming apparatus that forms an image.
